(19) United States
(12) Patent Application Publication
(10) Pub. No.: US 2026/0092887 A1
(43) Pub. Date: Apr. 2, 2026

(54) SENSORS USING POLYMERIC MATRICES

(71) Applicant: Government of the United States as represented by the Secretary of the Air Force, Wright-Patterson AFB, OH (US)

(72) Inventors: Michael C. Brothers, Lebanon, OH (US); Victoria E. Coyle, Dayton, OH (US); Steve S. Kim, Dayton, OH (US)

(21) Appl. No.: 18/903,330

(22) Filed: Oct. 1, 2024

(51) Int. Cl. G01N 27/327; G01N 27/30

(52) U.S. Cl. CPC G01N 27/3277; G01N 27/301

(57) ABSTRACT

A sensor that employs rationally designed polymeric and biopolymeric matrices by incorporating and maximizing key functional groups while eliminating interfering functional groups. A series of polymers and biopolymers designed with high aromaticity and negative charges to attract and detect monoamine redox active neurotransmitters (i.e., serotonin, dopamine, epinephrine, and norepinephrine) are disclosed and used in the disclosed sensor. Notably, these polymers and biopolymers are designed in such a way as to enable facile deposition onto surfaces either spontaneously or through quick electrodeposition. Such sensors typically employ a significantly reduced amount of PEDOT and can be used as a neurotransmitter sensor that can be used to monitor and/or diagnosis mood disorders, sleep disorders, cognition deficits, metabolite levels, neurological disorders; therapeutics level monitoring and/or identification. The aforementioned sensor can be wearable, implantable, multiuse or single use.

### RIGHTS OF THE GOVERNMENT

The invention described herein may be manufactured and used by or for the Government of the United States for all governmental purposes without the payment of any royalty.

### FIELD OF THE INVENTION

The present invention relates to sensors, and processes of making and using same.

### BACKGROUND OF THE INVENTION

Neurotransmitters are key signaling molecules in the body used to stimulate or depress neuronal activity. Dysregulation, such as reduced dopamine levels, are known to result in depression and reduced cognitive performance. Thus, monitoring the concentration of these analytes is important for human performance monitoring. Notably, while many groups have demonstrated conductive polymers for direct detection of redox active neurotransmitters including but not limited to serotonin, dopamine, epinephrine, and norepinephrine, none have focused on a rational approach to modify the surface focusing on key chemical interactions that can provide enhanced selectivity along with sensitivity.

A subset of neurotransmitters contain inherently redox active groups. These groups, whether a catecholamine or an indole ring, can be oxidized and reduced at specific potentials. Electrical potentials (electrochemistry) can be used to correlate current to concentration under specific conditions and experimental methods. Methods to create a change in current as a function of concentration include cyclic voltammetry (CV), differential pulse voltammetry (DPV), the derivative square wave voltammetry (SWV), and chronoamperometry (CA). While detection of neurotransmitters can occur at most electrodes including gold, carbon, and platinum, the sensitivity is typically below that necessary to monitor neurotransmitters in physiological fluids. While techniques can be used including Fast Scan Cyclic Voltammetry (FSCV) that provide sufficient sensitivity and time resolution, the selectivity of the technique is non-ideal.

In an attempt to solve the aforementioned sensor problems, to improve selectivity and sensitivity, improved materials that modify the surface of traditional electrodes (i.e., gold, carbon, platinum), including conductive polymers, whose larger surface areas and overall properties both enhance sensitivity and reduce the limit of detection have been developed. Unfortunately, conductive polymers, including Poly(3,4-ethylenedioxythiophene):polystyrene sulfonate (PEDOT:PSS), enhance sensitivity, but not selectivity via modification of the redox potential. Therefore, a rational design is needed to create conductive polymers and biopolymers that enhance sensitivity and selectivity towards redox active neurotransmitters.

Applicants recognized that the source of the aforementioned problem was complexity of the proffered solutions as the PEDOT, that is traditionally used to bind a conductive polymer to a surface, blocked the negative charge of PSS. Thus, the sensitivity and selectivity of the sensor is significantly reduced. Therefore, Applicants removed such complexity by removing a significant amount of PEDOT and herein disclose rationally designed peptides and electroactive polymeric matrices that effectively improve the sensitivity and selectivity towards sensors due to their introduction of both aromatic and negatively charged groups onto the electrode surface.

### SUMMARY OF THE INVENTION

A sensor that employs rationally designed polymeric and biopolymeric matrices by incorporating and maximizing key functional groups while eliminating interfering functional groups. A series of polymers and biopolymers designed with high aromaticity and negative charges to attract and detect monoamine redox active neurotransmitters (i.e., serotonin, dopamine, epinephrine, and norepinephrine) are disclosed and used in the disclosed sensor. Notably, these polymers and biopolymers are designed in such a way as to enable facile deposition onto surfaces either spontaneously or through quick electrodeposition. Such sensors typically employ a significantly reduced amount of PEDOT and can be used as a neurotransmitter sensor that can be used to monitor and/or diagnosis mood disorders, sleep disorders, cognition deficits, metabolite levels, neurological disorders; therapeutics level monitoring and/or identification. The aforementioned sensor can be wearable, implantable, multiuse or single use.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a schematic of the polymer polystyrene sulfonate (PSS) electrodeposited onto a glassy carbon (GC) to create a surface for sensing serotonin. The new sensor surface has a high density of aromatic rings as well as negative charged functional groups (sulfonates).

FIG. 2A is a schematic of a biopolymer, structured CDCWCDCW (CW), designed to enhance sensitivity and selectivity of redox active neurotransmitters at gold electrodes. Both peptides were design with 1) multiple cysteines to bind to the gold surface, 2) multiple carboxylate groups to create an overall negative charge, and 3) aromatic groups.

FIG. 2B is a schematic of a biopolymer, structured CDCDYCDCDY (CY), designed to enhance sensitivity and selectivity of redox active neurotransmitters at gold electrodes. Both peptides were design with 1) multiple cysteines to bind to the gold surface, 2) multiple carboxylate groups to create an overall negative charge, and 3) aromatic groups.

FIG. 3 depicts the current response of the bare GC compared to PEDOT:PSS and PSS to film alone to 6 micromolar of serotonin using the electrochemical technique differential pulse voltammetry (DPV).

FIG. 4 shows the DPV response of electrodeposited vinyl benzoic acid (VBA) in a solution of PBS with an addition of luM serotonin. VBA has a similar aromaticity and side-chains to PSS which cause the unique interaction between the sensor and serotonin.

FIG. 5A is a demonstration that the film thickness of PSS, which is correlated to the deposition time of PSS, influences sensor sensitivity to 6 micromolar of serotonin as observed by the peak at −0.2 V. Film thickness increases as the deposition time increases from 95 (FIG. 5a) seconds to 180 (FIG. 5b) seconds to 360 (FIG. 5c) seconds to 720 (FIG. 5d) seconds.

FIG. 5B is a demonstration that the film thickness of PSS, which is correlated to the deposition time of PSS, influences sensor sensitivity to 6 micromolar of serotonin as observed by the peak at −0.2 V. Herem film thickness increases as the deposition time increases from 95 seconds to 180.

FIG. 5C is a demonstration that the film thickness of PSS, which is correlated to the deposition time of PSS, influences sensor sensitivity to 6 micromolar of serotonin as observed by the peak at −0.2 V. Here, film thickness increases as the deposition time increases from 180 seconds to 360 seconds.

FIG. 5D is a demonstration that the film thickness of PSS, which is correlated to the deposition time of PSS, influences sensor sensitivity to 6 micromolar of serotonin as observed by the peak at −0.2 V. Here, film thickness increases as the deposition time increases from 360 seconds to 720 seconds.

FIG. 6 depicts the DPV responses of GC-PSS sensors to 1 uM Serotonin with varying concentrations of PSS present during electrodeposition. Volumes of PSS were varied between 2 to 60 uL in 10 mL of eluent to show varying PSS concentration varies peak current at −0.2V and +0.3V.

FIG. 7A demonstrate the change in peak height at −0.2 V as a function of serotonin concentration for a GC electrode coated with PEDOT:PSS.

FIG. 7B demonstrate the change in peak height at −0.2 V as a function of serotonin concentration for a GC electrode coated only PSS showing greater sensitivity is observed when the PEDOT component is removed from sensor fabrication.

FIG. 8A depicts the DPV responses of GC-PEDOT:PSS sensors to 1 uM Serotonin with low concentrations of EDOT present during electrodeposition to observe sensor impediment. Volumes of EDOT were reduced to 0.02%.

FIG. 8B depicts the DPV responses of GC-PEDOT:PSS sensors to 1 uM Serotonin with low concentrations of EDOT present during electrodeposition to observe sensor impediment. Volumes of EDOT were reduced to 0.01% volume showing an impediment in observed peak at −0.2V.

FIG. 9A demonstrates that common interfering agents at 10× the maximum observed physiological concentrations do not interfere with sensing of serotonin on the GC-PSS electrode. Raw DPV response with all non-interacting species represented by solid line and contaminant response vs buffer response of each contaminating species shown in FIG. 9B.

FIG. 9B demonstrates that common interfering agents at 10× the maximum observed physiological concentrations do not interfere with sensing of serotonin on the GC-PSS electrode. Contaminant response vs buffer response of each contaminating species is shown.

FIG. 10A demonstrates the response of GC-PSS to serotonin in 100% human serum with Serotonin additions between 0.1 and 2 uM. Raw DPV response is shown.

FIG. 10B demonstrates the response of GC-PSS to serotonin in 100% human serum with Serotonin additions between 0.1 and 2 uM. A corresponding peak current and calibration curve to FIG. 10A is depicted.

FIG. 11A demonstrates the response of GC-PSS to serotonin in 10% human serum, a simulant of interstitial fluid, with Serotonin additions between 0.1 and 6 uM. Raw DPV response is shown.

FIG. 11B demonstrates the response of GC-PSS to serotonin in 10% human serum, a simulant of interstitial fluid, with Serotonin additions between 0.1 and 6 uM. The corresponding peak current and calibration curve to FIG. 11A is depicted.

FIG. 12A demonstrates the DPV response of GC-PSS coated with the hydrogel methylcellulose (MeC) to dopamine concentrations between 2 and 100 uM in human saliva.

FIG. 12B depicts the corresponding calibration curve of peak area to FIG. A (FIG. 12b).

FIG. 13A shows human saliva run to baseline (dotted line) with an addition of 10 uM Dopamine.

FIG. 13B shows human saliva run to baseline (dotted line) with an addition of 10 uM Dopamine and an addition of norepinephrine.

FIG. 14A shows pure response of the GC-PSS-MeC to human saliva and its variability with repeated scans (n=4) FIG. 14B demonstrates the ability of GC-PSS-MeC sensor to detect acetaminophen in saliva, as observed by the absence (left) or presence (right) of a peak at ˜0.35 V.

FIG. 15 demonstrates two biopolymers (CY (left) and CW (right)) deposited on gold surface used to determine the concentration of serotonin. Both polymers had two voltages where the change in the peak height correlated to the concentration.

FIG. 16A is an example schematic of lab set-up for electrochemical experiments of showing a front and top down view wherein CE is a counter electrode, WE is a working electrode and Reis a reference electrode.

FIG. 16B is an example schematic of a single chip form showing electrode positioning for optimal sensing performance wherein CE is a counter electrode, WE is a working electrode and Reis a reference electrode.

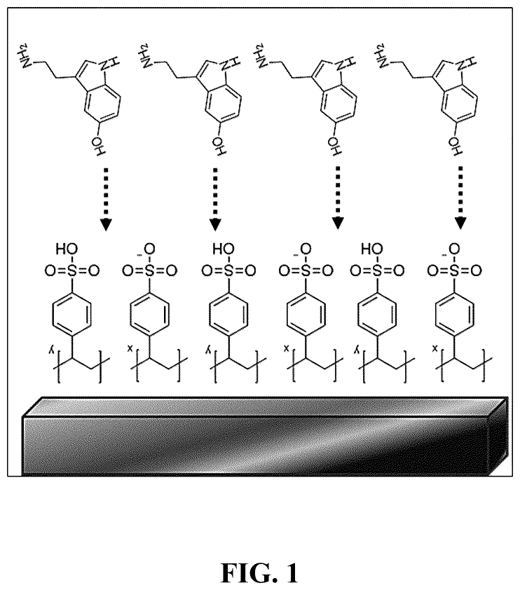

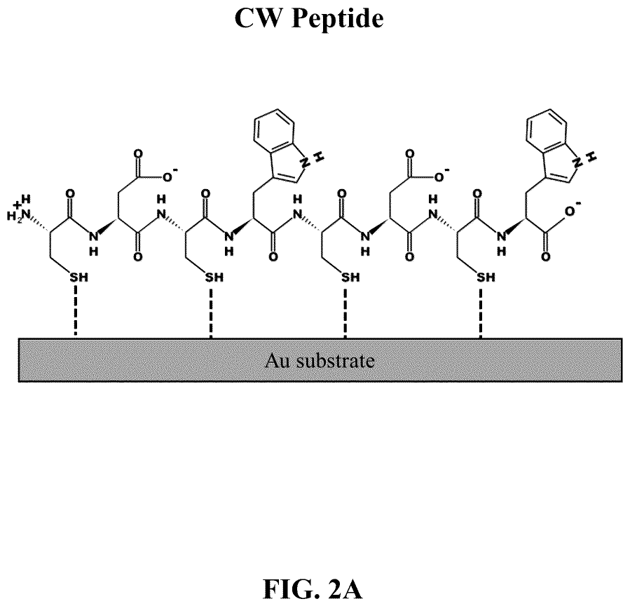

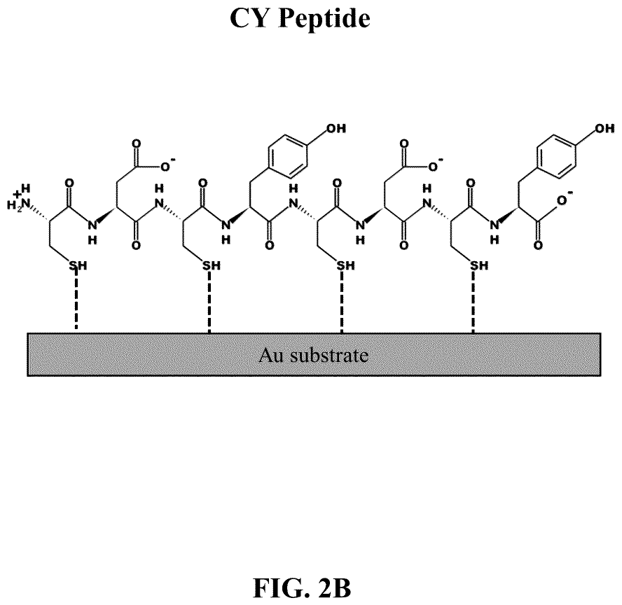

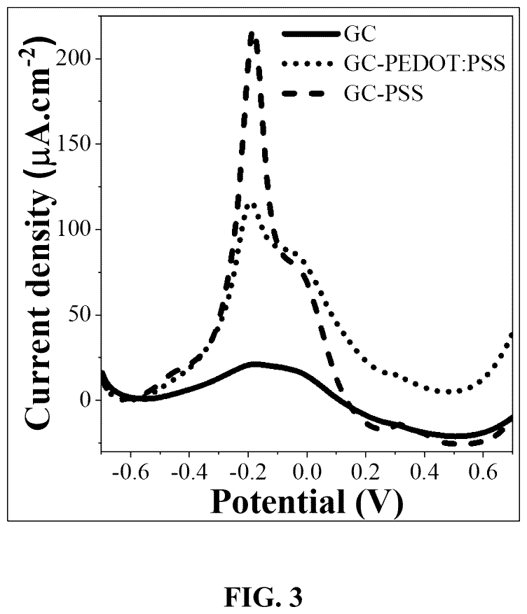

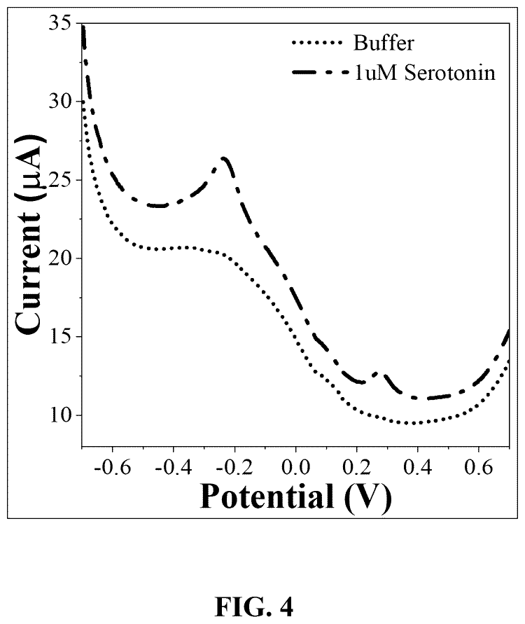

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately,” or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A and/or B) that the embodiment may have element A alone, element B alone, or elements A and B taken together.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Sensor, Article Comprising Sensor and Method of Use

For purposes of this specification, headings are not considered paragraphs. In this paragraph, Applicants disclose a sensor comprising: a substrate having a surface area that comprises a material selected from the group consisting of conductive substrates and mixtures thereof, preferably said substrate comprises a material selected from the group consisting of gold, carbon and mixtures thereof, more preferably substrate comprises a material selected from the group consisting of graphene, graphite, glassy carbon and mixtures thereof, most preferably said substrate comprises a material selected from the group consisting of glassy carbon and mixtures thereof; a polymer containing a plurality of aromatic functional groups and negatively charged functional groups, preferably said polymer is selected from the group consisting of polystyrene sulfonate, polybenzoate, polytryptophan, polytyrosine, polyglutamate, polyaspartate and mixtures thereof, more preferably said polymer comprises a material selected from the group consisting of polystyrene sulfonate, polybenzoate, and mixtures thereof; most preferably said polymer comprises polystyrene sulfonate; said polymer being disposed on said surface of said substrate; with the proviso that said polymer comprises less than 33% by total polymer weight of one or more positively charged polymers, preferably said polymer comprises less than 10% by total polymer weight of one or more positively charged polymers, more preferably said polymer comprises less than 5% by total polymer weight of one or more positively charged polymers, most preferably said polymer comprises less than 1% by total polymer weight of one or more positively charged polymers, in one aspect, said positively charged polymers comprise poly(3,4-ethylenedioxythiophene); and at least two electrodes, preferably at least three electrodes, at least one of said electrodes being in contact with said polymer, preferably said electrodes comprise silver, silver chloride, platinum, palladium, palladium oxide, rhodium, osmium, gold, carbon, iridium, iridium oxide, ruthenium, ruthenium oxide and mixtures thereof; more preferably said electrodes comprise carbon, platinum, silver, and mixtures thereof, most preferably at least one electrode comprises glassy carbon, silver, silver chloride, platinum and mixtures thereof.

Applicants disclose the sensor according to the previous paragraph wherein said three electrodes are a counter electrode, a working electrode and a reference electrode, preferably said three electrodes being equidistant apart with said working electrode being positioned between the reference electrode and counter electrode, more preferably said three electrodes are spaced equidistant apart in a triangular arrangement. In one aspect, the electrodes are spaced equidistant apart when the distance between the electrodes varies by no more than 50%, preferably no more that 25%, more preferably no more than 10% and most preferably no more than 5%.

Applicants disclose the sensor according to the previous two paragraphs wherein the polymer is electrochemically bound and/or electropolymerized to at least one of said electrodes.

Applicants disclose the sensor according to the previous three paragraphs wherein said polybenzoate, polytryptophan, polytyrosine, polyglutamate and polyaspartate comprise one or more thiol containing moieties.

Applicants disclose the sensor according to the previous four paragraphs wherein the polymer is coated with a hydrogel, preferably said hydrogel comprises agarose, chitosan, carboxymethylcellulose and/or acrylamide.

Applicants disclose the sensor according to the previous five paragraphs wherein said sensor is a chip.

Applicants disclose an article comprising a sensor according to any of the previous six paragraphs, preferably said article comprises the sensor of the previous paragraph wherein said sensor is a chip; preferably said article is a garment, an appliance, a medical device, an analytical instrument or protective device, in one aspect, said garment is a shirt, coat, skirt, pant, short, dress, suit, underwear swimsuit, uniform; in one aspect, said appliance is a blender, food processor, juicer; in one aspect, said medical device is an implantable, monitor, smartwatch, patch, ring, headband; in one aspect, said analytical instrument is a spectrometer, analyzer, chromatograph, microscope; and in one aspect, said protective device is goggles and/or eye protection, gloves, mouthguard, masks, boots and/or foot protection, earplugs and/or ear protection, respirators, overalls and/or protective clothing, helmets and/or head protection, leggings and/or leg protection. Said sensor can be incorporated into said articles by weaving, ink-printing, evaporation techniques, deposition techniques, microneedle incorporation, embedment, lithography, pressing, roll to roll, dip coating, blading, drop casting, brush coating, stamping, ink-writing.

In this paragraph, Applicants disclose a method of determining the concentration of one or more analytes of interest, said method comprising: establishing a baseline by exposing a sensor of disclosed in the previous paragraphs to a buffer solution that is free of any analytes of interest; creating, by electrochemical detection, a first analyte concentration reference data set and analyte potential interaction data set for one or more analytes of interest by exposing a sensor of disclosed in the previous paragraphs to one or more buffer solutions, each of said one or more buffer solutions comprising a known concentration of at least one analytes of interest; creating, by electrochemical detection, a second analyte concentration reference data set and analyte potential interaction data set for one or more solutions comprising unknown concentrations of one or more analytes of interest by exposing the sensor a sensor of disclosed in the previous paragraphs to said one or more solutions comprising said unknown concentration of at least one analyte of interest; comparing said first analyte concentration reference data set and analyte potential interaction data set and said second analyte concentration reference data set and analyte potential interaction data set to generate the concentration of said one or more analytes of interest in said one or more solutions of the previous step.

In this paragraph, Applicants disclose the method of the previous paragraph wherein said one or more analytes are neurotransmitters, preferably said one or more analytes comprise a material comprising an indole or a catecholamine, most preferably said one or more analytes comprise serotonin, tryptophan, dopamine, norepinephrine and/or epinephrine.

In this paragraph, Applicants disclose the method of the previous two paragraphs wherein said electrochemical detection comprises differential pulse voltammetry or square wave voltammetry.

In this paragraph, Applicants disclose the method of the previous paragraph wherein the method comprises differential pulse voltammetry, preferably said differential pulse voltammetry measurement is run between −2 and +2 volts at a scan r; more preferably, the differential pulse voltammetry measurement is run between −1.0 and +1.0 V; most preferably the differential pulse voltammetry measurement is run between −0.7 to 0.7 V.

In this paragraph, Applicants disclose the method of the previous four paragraphs wherein the one or more solutions comprising unknown concentrations of one or more analytes comprises a biofluid.

In this paragraph, Applicants disclose the method of the previous five paragraphs wherein the biofluid is interstitial fluid, blood, saliva, spit, urine and/or sweat.

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

### EXAMPLES

### Example 1

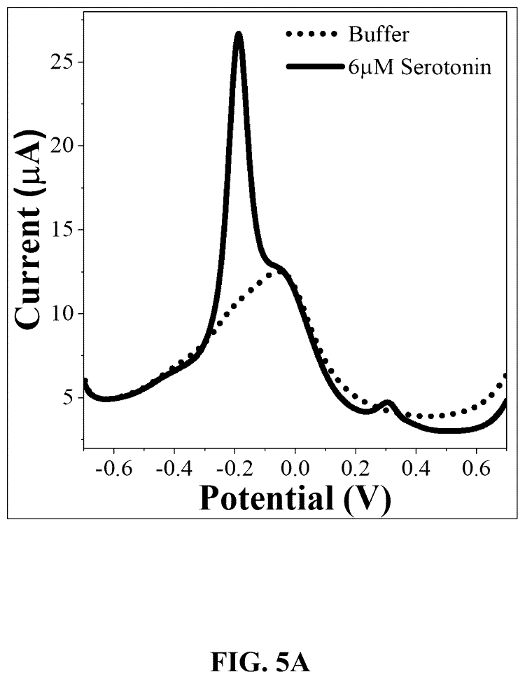

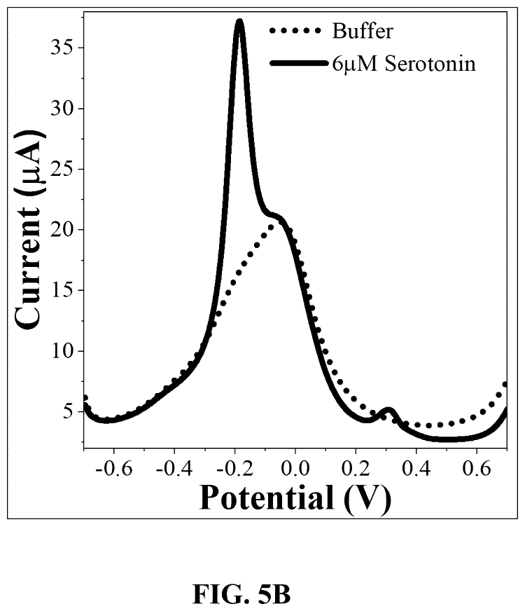

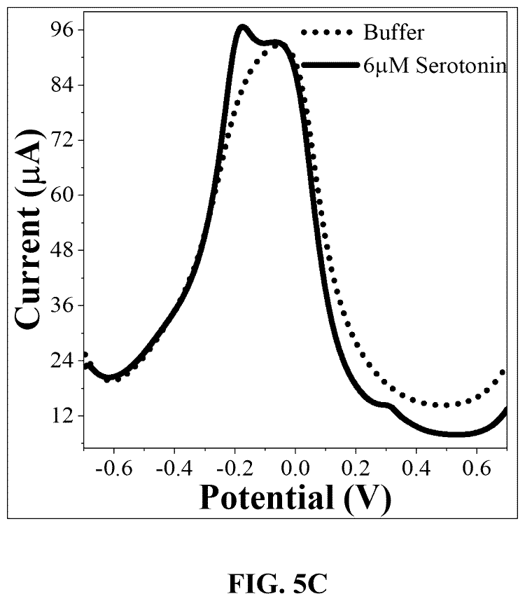

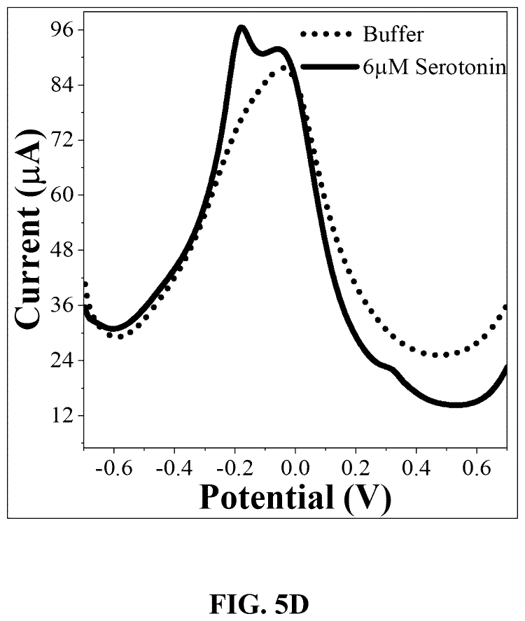

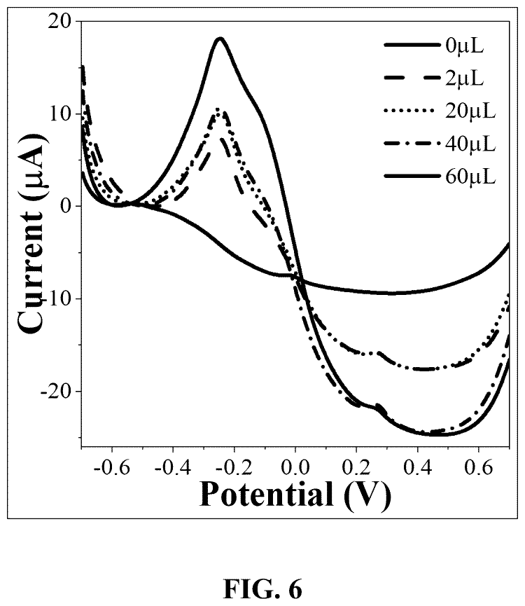

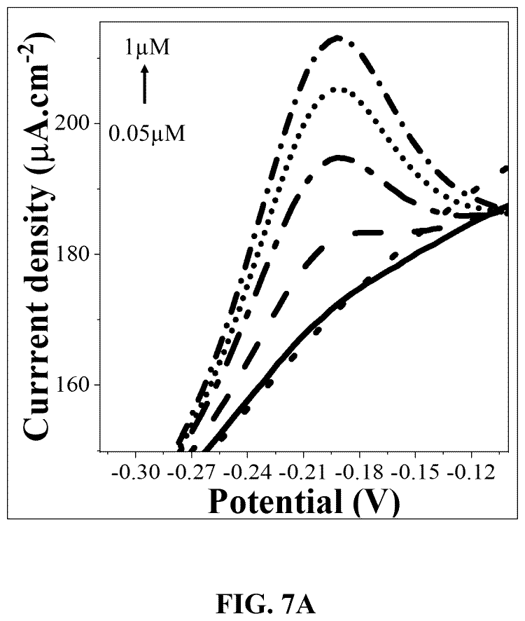

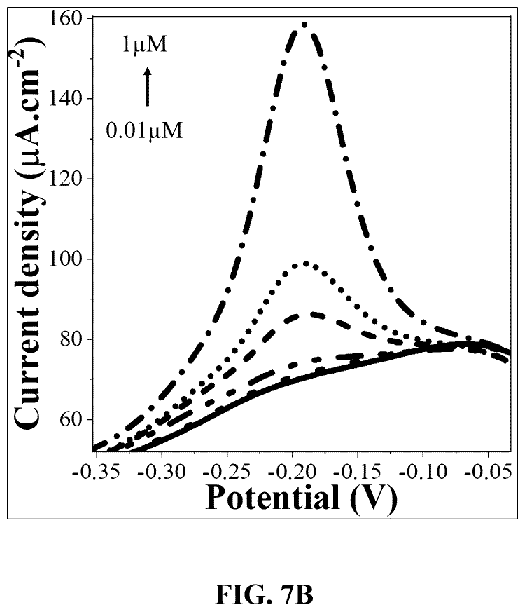

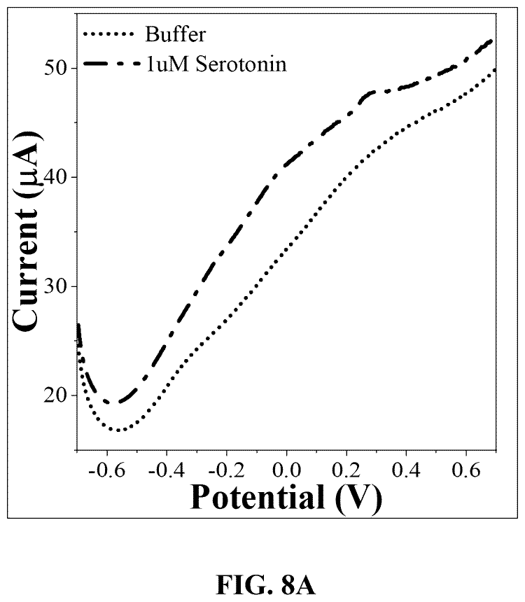

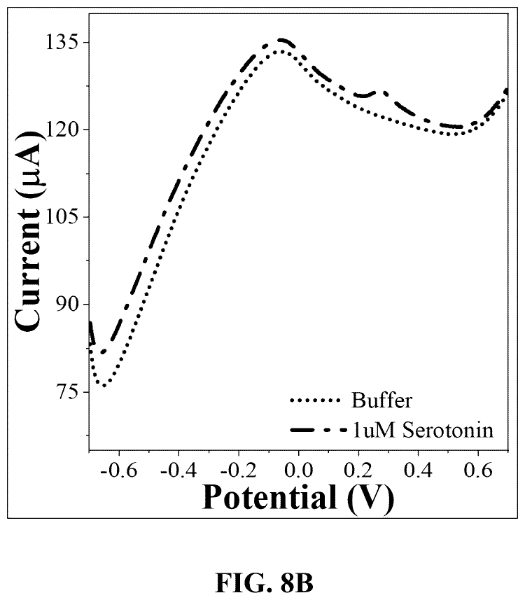

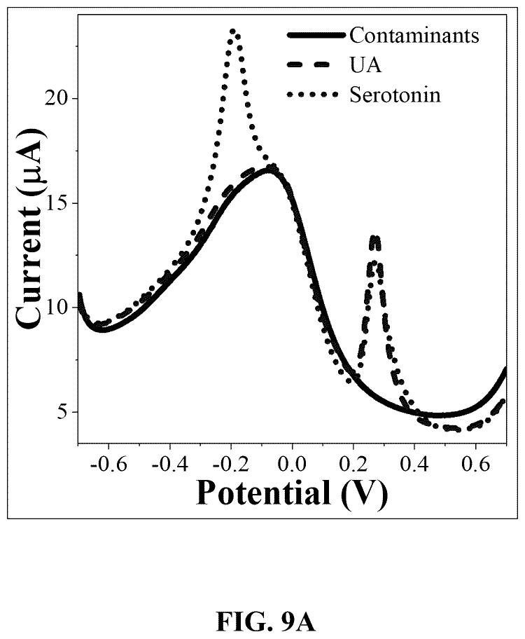

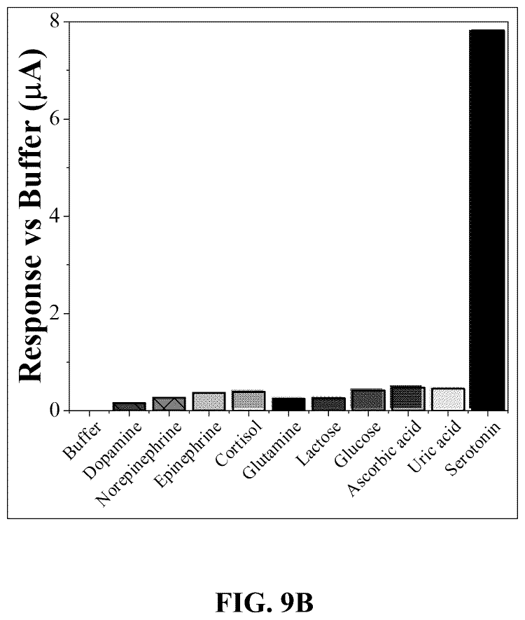

PSS was electrodeposited onto a GC disc electrode for times ranging from 95 seconds to 720 seconds. The glassy carbon rod was then interrogated in a three-electrode cell consisting of PSS-GC working electrode, a silver/silver chloride reference, and a Pt counter electrode. Differential pulse voltammetry (DPV) was performed by using the following parameters: Scan range of −0.7 to +0.7 V; AC amplitude of 50 mV; pulse width of 0.5 s; sampling width of 0.0167 s; and pulse period of 0.5 s. The peak at −0.2V was then measured before and after the addition of 6 micromolar of serotonin (FIG. 5). Increasing concentrations of serotonin can be titrated into the sensor and the peak height reported and correlated to concentration (FIG. 7b). This peak is unique to serotonin among other interfering agents tested, including dopamine, norepinephrine, cortisol, glutamine, lactate, ascorbic acid, and uric acid (FIG. 9).

### Example 2

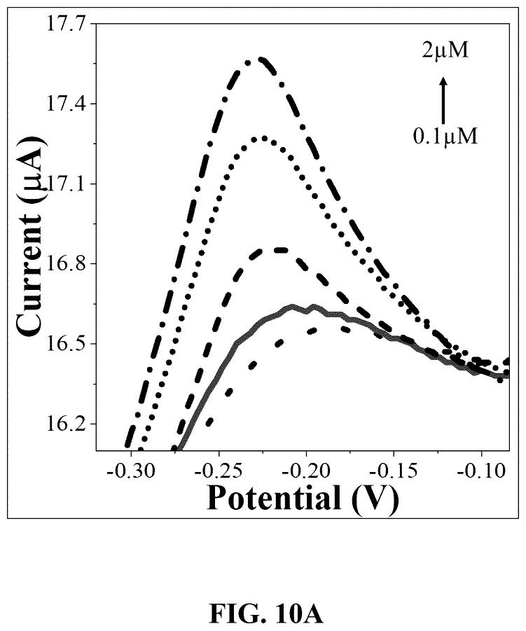

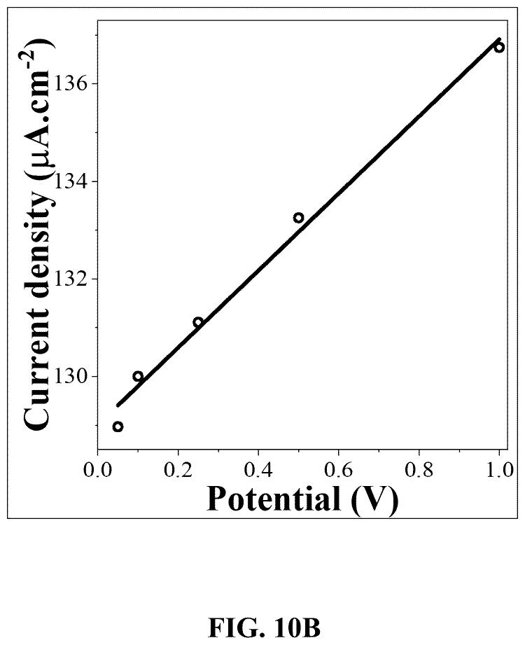

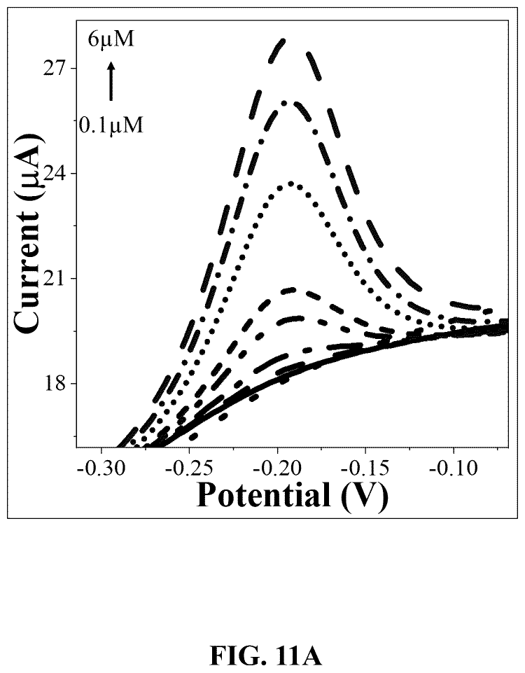

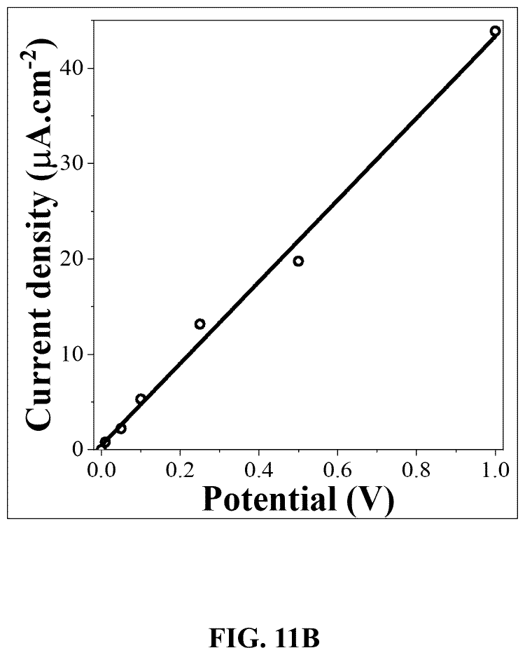

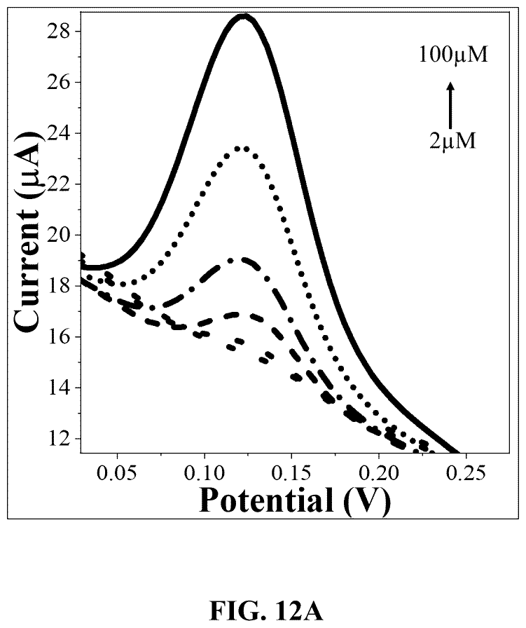

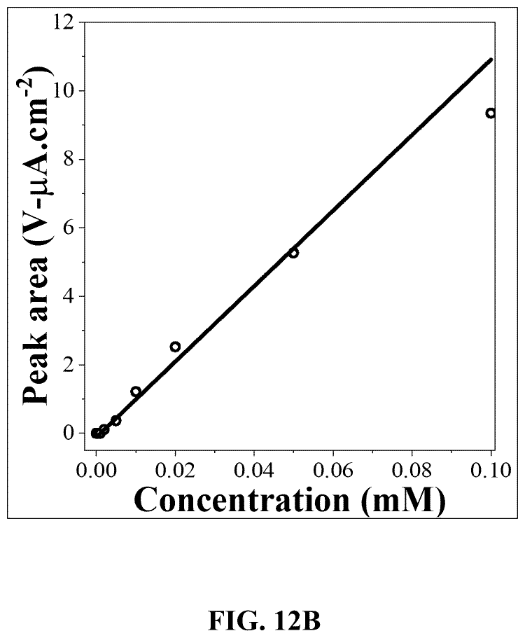

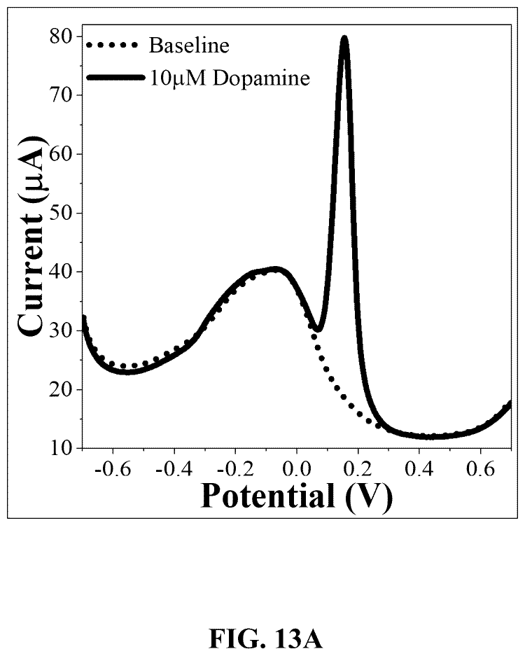

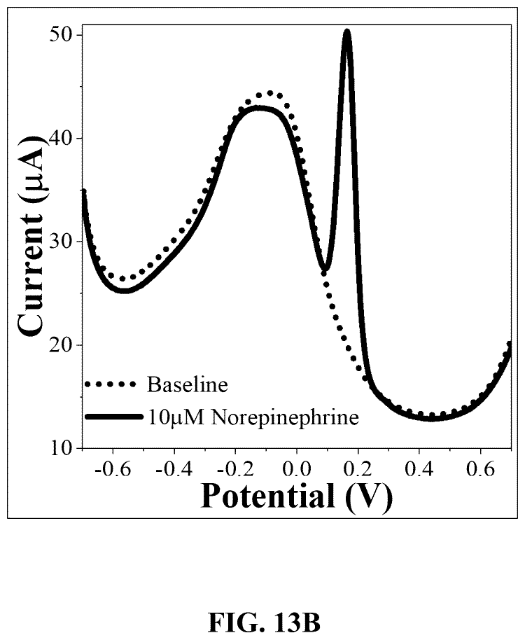

PSS was electrodeposited onto a GC disc electrode for 95 seconds. The GC-PSS electrode was then placed in a three-electrode cell consisting of a PSS-GC working electrode, a silver/silver chloride reference, and a Pt counter electrode. The sensor was then interrogated in the presence of either 100% human serum (FIG. 10) or 10% human serum (FIG. 11) using DPV. DPV was performed by using the following parameters: Scan range of −0.7 to +0.7 V; AC amplitude of 50 mV; pulse width of 0.5 s; sampling width of 0.0167 s; and pulse period of 0.5 s. The peak at −0.2 V was reported and correlated as a function of serotonin concentration in this complex media; it should be noted that the complex media appeared to suppress the sensitivity of the sensor.

### Example 3

PSS was electrodeposited onto a GC disc electrode for 95 seconds. The glassy carbon rod then had carboxymethylcellulose (MeC) (˜50 microliters) deposited on-top to form a hydrogel filter. The GC-PSS-MeC electrode was then placed in a three-electrode cell consisting of a PSS-GC-MeC working electrode, a silver/silver chloride reference, and a Pt counter electrode. The sensor was then interrogated in the presence of human saliva using DPV. DPV was performed by using the following parameters: Scan range of −0.7 to +0.7 V; AC amplitude of 50 m V; pulse width of 0.5 s; sampling width of 0.0167 s; and pulse period of 0.5 s. The peak at 0.2 V was then reported as a function of dopamine concentration.

### Example 4

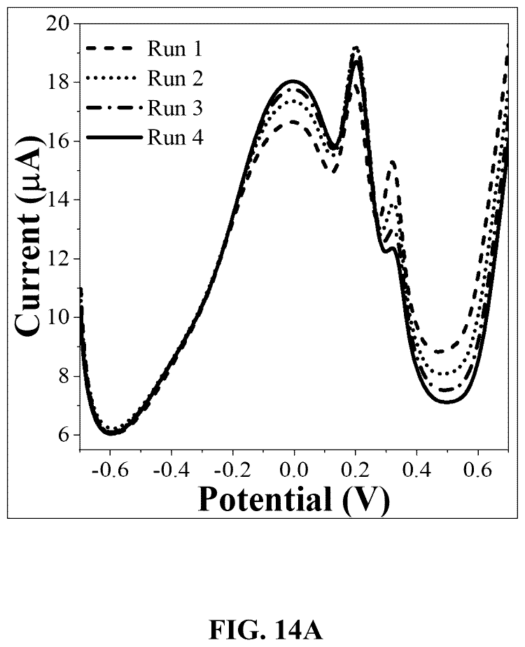

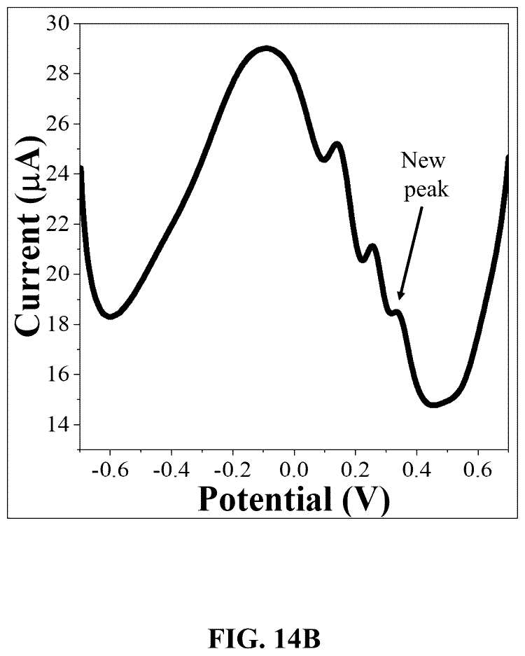

PSS was electrodeposited onto a GC disc electrode for 95 seconds. The glassy carbon rod then had MeC (˜50 microliters) deposited on-top to form a hydrogel filter. The GC-PSS-MeC electrode was then placed in a three-electrode cell consisting of a PSS-GC-MeC working electrode, a silver/silver chloride reference, and a Pt counter electrode. The sensor was then interrogated in the presence of human saliva using DPV. DPV was performed by using the following parameters: Scan range of −0.7 to +0.7 V; AC amplitude of 50 mV; pulse width of 0.5 s; sampling width of 0.0167 s; and pulse period of 0.5 s. The peak at 0.3V only appeared on days when the subject had taken acetaminophen (FIG. 14b).

### Example 5

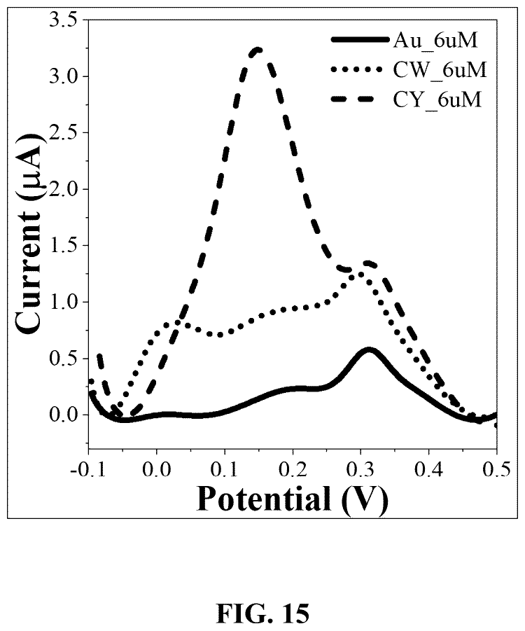

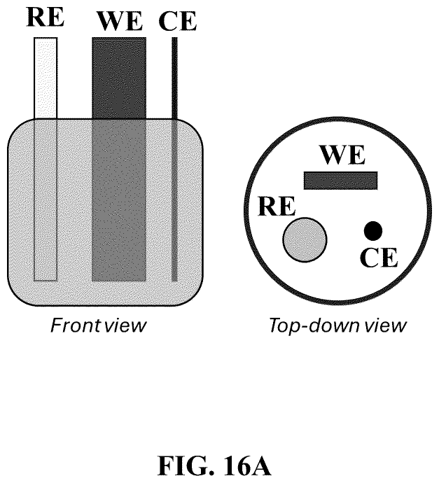

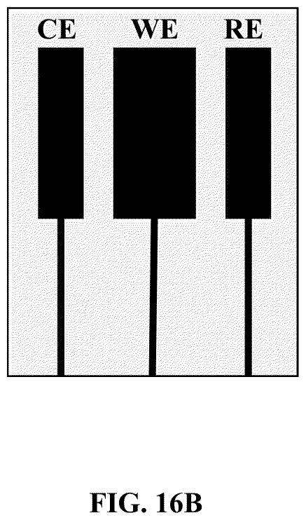

Gold disc electrodes were soaked in 1 micromolar CY peptide through spontaneous formation of gold thiol bonds. The sensor was rinsed and then placed in a three electrode cell with a silver/silver chloride reference, and a Pt counter electrode. Differential pulse voltammetry (DPV) was performed by using the following parameters: Scan range of −0.7 to +0.7 V; AC amplitude of 50 mV; pulse width of 0.5 s; sampling width of 0.0167 s; and pulse period of 0.5 s The peaks at 0.0 V and 0.3 V increased as a function of serotonin concentration and correlated with concentration (FIG. 15 dashed line).

### Example 6

Gold disc electrodes were soaked in 1 micromolar CW peptide through spontaneous formation of gold thiol bonds. The sensor was rinsed and then placed in a three electrode cell with a silver/silver chloride reference, and a Pt counter electrode. Differential pulse voltammetry (DPV) was performed by using the following parameters: Scan range of −0.7 to +0.7 V; AC amplitude of 50 mV; pulse width of 0.5 s; sampling width of 0.0167 s; and pulse period of 0.5 s The peaks at 0.3 V decreased as a function of serotonin concentration and correlated with concentration (FIG. 15 dotted line).

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A sensor comprising:
a) a substrate having a surface area that comprises a material selected from the group consisting of conductive substrates and mixtures thereof;
b) a polymer containing a plurality of aromatic functional groups and negatively charged functional groups, with the proviso that said polymer comprises less than 33% by total polymer weight of one or more positively charged polymers; and
c) at least two electrodes.

2. The sensor of claim 1 wherein said sensor comprises at least three electrodes, at least one of said electrodes being in contact with said polymer, said substrate comprises a material selected from the group consisting of gold, carbon and mixtures thereof, said polymer is selected from the group consisting of polystyrene sulfonate, polybenzoate, polytryptophan, polytyrosine, polyglutamate, polyaspartate and mixtures thereof and said polymer comprises less than 10% by total polymer weight of one or more positively charged polymers.

3. The sensor of claim 2 wherein said substrate comprises a material selected from the group consisting of graphene, graphite, glassy carbon and mixtures thereof, said polymer comprises a material selected from the group consisting of polystyrene sulfonate, polybenzoate, and mixtures thereof, said electrodes comprise silver, silver chloride, platinum, palladium, palladium oxide, rhodium, osmium, gold, carbon, iridium, iridium oxide, ruthenium, ruthenium oxide and mixtures thereof and said polymer comprises less than 5% by total polymer weight of one or more positively charged polymers.

4. The sensor of claim 3 wherein said substrate comprises a material selected from the group consisting of glassy carbon and mixtures thereof, said polymer comprises polystyrene sulfonate; said polymer being disposed on said surface of said substrate; said electrodes comprise carbon, platinum, silver, and mixtures thereof and said polymer comprises less than 1% by total polymer weight of one or more positively charged polymers.

5. The sensor of claim 1 wherein at least one electrode comprises glassy carbon, silver, silver chloride, platinum and mixtures thereof.

6. The sensor of claim 1 wherein said one or more positively charged polymers comprise poly(3,4-ethylenedioxythiophene).

7. The sensor of claim 1 wherein said three electrodes are a counter electrode, a working electrode and a reference electrode.

8. The sensor of claim 7 wherein said three electrodes are equidistant apart with said working electrode being positioned between the reference electrode and counter electrode.

9. The sensor of claim 8 wherein said three electrodes are spaced equidistant apart in a triangular arrangement.

10. The sensor of claim 1 wherein the polymer is electrochemically bound and/or electropolymerized to at least one of said electrodes.

11. The sensor of claim 1 wherein said polybenzoate, polytryptophan, polytyrosine, polyglutamate and polyaspartate comprise one or more thiol containing moieties.

12. The sensor of claim 1 wherein the polymer is coated with a hydrogel.

13. The sensor of claim 12 wherein said hydrogel comprises agarose, chitosan, carboxymethylcellulose and/or acrylamide.

14. The sensor of claim 1, said sensor being a chip.

15. An article comprising the sensor of claim 1.

16. An article according to claim 15, said article being a garment, an appliance, a medical device, an analytical instrument or protective device.

17. A method of determining the concentration of one or more analytes of interest, said method comprising:
a) establishing a baseline by exposing a sensor according to claim 1 to a buffer solution that is free of any analytes of interest;
b) creating, by electrochemical detection, a first analyte concentration reference data set and analyte potential interaction data set for one or more analytes of interest by exposing a sensor according to claim 1 to one or more buffer solutions, each of said one or more buffer solutions comprising a known concentration of at least one analytes of interest;
c) creating, by electrochemical detection, a second analyte concentration reference data set and analyte potential interaction data set for one or more solutions comprising unknown concentrations of one or more analytes of interest by exposing a sensor according to claim 1 to said one or more solutions comprising said unknown concentration of at least one analyte of interest; and
d) comparing said first analyte concentration reference data set and analyte potential interaction data set and said second analyte concentration reference data set and analyte potential interaction data set to generate the concentration of said one or more analytes of interest in said one or more solutions of step c).

18. The method of claim 17 wherein said one or more analytes are neurotransmitters.

19. The method of claim 18 wherein said one or more analytes comprise a material comprising an indole or a catecholamine.

20. The method of claim 19 wherein said one or more analytes comprise serotonin, tryptophan, dopamine, norepinephrine and/or epinephrine.

21. The method of claim 17 wherein said electrochemical detection comprises differential pulse voltammetry or square wave voltammetry.

22. The method of claim 21 wherein the method comprises differential pulse voltammetry.

23. The method of claim 22 wherein said differential pulse voltammetry measurement is run between −2 and +2 volts at a scan r.

24. The method of claim 23 wherein the differential pulse voltammetry measurement is run between −1.0 and +1.0 V;

25. The method of claim 24 wherein the differential pulse voltammetry measurement is run between −0.7 to 0.7 V.

26. The method of claim 17 wherein the one or more solutions comprising unknown concentrations of one or more analytes comprises a biofluid.

27. The method of claim 26 wherein the biofluid is interstitial fluid, blood, saliva, spit, urine and/or sweat.
